(19) United States
(12) Patent Application Publication
(10) Pub. No.: US 2023/0318749 A1
(43) Pub. Date: Oct. 5, 2023

(54) TRAINING A MACHINE LEARNING MODEL USING TRANSMISSIONS BETWEEN RESERVED HARQ RESOURCES IN A COMMUNICATIONS NETWORK

(71) Applicant: Telefonaktiebolaget LM Ericsson (publ), Stockholm (SE)

(72) Inventors: Eduardo LINS DE MEDEIROS, Sundbyberg (SE); Pedro BATISTA, Sollentuna (SE)

(73) Assignee: TELEFONAKTIEBOLAGET LM ERICSSON (PUBL), Stockholm (SE)

(21) Appl. No.: 18/022,221

(22) PCT Filed: Aug. 21, 2020
(86) PCT No.: PCT/SE2020/050810

§ 371 Date: Feb. 20, 2023

(51) Int. Cl. H04L 1/1812; H04W 28/26; H04B 17/00; H04W 48/20; H04B 7/0452

(52) U.S. Cl. CPC H04L 1/1812; H04W 28/26; H04B 17/0085; H04W 48/20; H04B 7/0452

(57) ABSTRACT

A method performed by a first node in a communications network for use in training a model using a machine learning process using Hybrid Automatic Repeat Request, HARQ, transmissions. The method includes reserving HARQ resources between a second node and a third node in the communications network for training of the model. The method further includes initiating a first test transmission from the second node to the third node using the reserved HARQ resources in order to obtain data with which to train the model.

### TECHNICAL FIELD

This disclosure relates to methods, nodes and systems in a communications network. More particularly but non-exclusively, the disclosure relates to methods and nodes for use in training a model using a machine learning process using Hybrid Automatic Repeat Request, HARQ, transmissions.

### BACKGROUND

In many problems related to the physical layer of radio systems it is difficult or even impossible to provide optimal or efficient solutions based on traditional optimization methods or closed form solutions. An alternative way to solve those problems is to use artificial intelligence (AI) technology (e.g. neural networks, reinforcement learning agents), that can find satisfactory solutions by learning from observations (data) and experimenting with the environment (taking actions and observing outcomes). These methods benefit from large datasets. Large both in terms of number of samples and in their variability, e.g., the dataset is more valuable when they have many samples on many different states.

Those diverse datasets are difficult to obtain because, ideally, they should be collected from live systems. However, live networks are operating in specific conditions, most of the time in conservative states from which the samples are drawn from. This may limit the AI agents' ability to learn from new data and might limit its performance.

Furthermore, mobile networks are an ever-changing environment and for AI to perform well it must always have access to new operating conditions (taking exploratory decisions, or actions), especially when the environment changes, because an action that was not good in the past environment might be good in its current situation (or the other way around). However, performing exploratory (e.g. essentially random) actions in a network environment may not lead to good outcomes and could lead to performance degradation.

In Third Generation Partnership Project (3GPP) based Fourth Generation (4G) and Fifth Generation (5G) systems, the radio access technology (RAT) is based on Orthogonal Frequency-Division Multiplexing (OFDM). These systems achieve high throughputs and are robust to hostile propagation environments due to strong and flexible channel coding. Even though Long-Term Evolution (LTE) and New Radio (NR) use different channel coding techniques (e.g. Turbo codes, Low-Density Parity Check Codes, LDPC) they share the same principle of achieving incremental redundancy through Hybrid Automatic Repeat Request (HARQ) methods. In short HARQ allows for physical layer retransmissions driven by decode errors at the receiver. Each retransmission may carry a different set of systematic bits that help the receiver find and correct errors.

Each transmitter in LTE and NR has a set of HARQ processes that receive transport blocks (TB-groups of bytes that have been encoded for transmission) from the Medium Access Control (MAC) layer. A HARQ process is responsible for correct delivery of its assigned transport block to the receiver. For this, the modulation and coding scheme used to prepare the transport block are chosen to achieve a certain block error rate, the principle being that one will use strong coding for bad channel conditions and more efficient options (less redundant bits) when the signal-to-interference-and-noise ratio (SINR) is high.

A HARQ process can be understood as an identifier attached to a sequence of transmissions aimed at correct delivery of a chunk of data (transport block) between base station and UE. When the first attempt of delivering a transport block is made, it is assigned a (free) HARQ process identifier. Until a positive acknowledgement is received by the base station, subsequent transmission attempts use the same HARQ process (that way the UE knows which transmission attempts to combine in order to improve decoding performance). While in this loop, the HARQ process is “blocked”, meaning it is not used to transmit other transport blocks of data to the UE.

Further information on HARQ processes may be found in 3GPP documents TS 38.321 and TS 38.214.

It is an object herein to improve on methods of training a model using a machine learning process in a communications network.

### SUMMARY

As noted above, data is a central consideration for training AI for both machine learning and machine reasoning. Examples of machine learning data include but are not limited to: Labeled data for supervised learning models; unlabeled data for unsupervised learning models; and State-action-reward sets for reinforcement learning agents. Furthermore, in machine reasoning, the decisions taken by the reasoning agent may be based on its knowledge base which is derived from data.

Reinforcement learning (RL) involves the use of RL agents that learn from interaction with the environment in which (state, action, reward, next state) tuples (or experience) are collected. During training the agent will learn the relationship between action and reward in each state so as to, in the future when faced with the same state, be able to propose actions that improve the reward. The agent only understands if a decision (action) is good or bad after trying it, thus it needs to try actions to explore the effects of said actions. In reinforcement learning, performing new actions is called exploration. Exploration is risky in its nature, since the consequences of the actions are unknown and might therefore lead to undesirable system outcomes. Exploration is important however in order for the reinforcement learning agent to explore or sample the full action space and thus learn optimal actions to perform.

A common exploration method in RL is epsilon-greedy exploration, where the agent tries a random action (e.g., exploration) with probability epsilon, and takes the action that maximizes the expected reward based on its current experience (e.g., exploitation) with the probability 1-epsilon.

For reinforcement learning agents deployed in a Radio Access Network (RAN), it is undesirable to allow such training, as those explorations with random actions, even with small epsilon probability, could incur significant degradation in service quality. Thus, RL agents are typically pre-trained before being deployed. However, even pre-trained agents, must keep exploring the environment, to keep up with such a dynamic environment.

In some known methods, a model may be trained on the live system, but by constraining the search universe so as to guarantee e.g. certain performance ranges. However, this might limit actions that could be good but are outside of the search universe. In another approach an agent is trained in a digital environment (simulated) and used in a real environment. However this is limited by how realistic the digital environment is and how fast it can track changes in the real environment.

For other types of modes, such as supervised or unsupervised models, learning may be performed on data collected in the live network. However, such data does not always capture all the possible network states that the model might encounter once deployed in a real network. Moreover, in both pre-training and online learning, the agent is inherently exposed to an imbalanced dataset, e.g., since most cells spend a considerable amount of time in low-load (as opposed to peak demand) or conservative states, datasets of observations will inherit this imbalance. For AI methods, that means it will have little exposure to some scenarios and may perform poorly on those cases.

Dealing with exploration and/or on-going (e.g. such as live or on-line) training of models trained using machine learning processes in a RAN environment thus remains an issue. It is an object of embodiments herein to improve on this situation.

Thus according to a first embodiment there is a method performed by a first node in a communications network for use in training a model using a machine learning process based using on Hybrid Automatic Repeat Request, HARQ, transmissions. The method comprises reserving HARQ resources between a second node and a third node in the communications network for training of the model, and initiating a first test transmission from the second node to the third node using the reserved HARQ resources in order to obtain data with which to train the model.

Embodiments herein may thus facilitate transparent data collection and experimentation when training models using a machine learning process; for example in the physical (PHY) layer in a RAN. Experimentation and data collection in RAN is enabled by reserving a subset of HARQ processes (in a base station, serving cell and UE) in such a way that most parameters in the physical layer can be experimented with. The isolation of HARQ processes ensures minimal impact to the performance of the network while enabling flexibility of use cases.

The systems and methods herein may be equivalent to creating a slice in the physical layer (PHY) for experimentation, e.g. that is completely independent of the other legitimate uses of the network (user plane data transmissions). By using reserved HARQ resources, data collection and experimentation can be carried out at the most granular level, enabling the first node (AI model, data gathering) to experiment in the live conditions (deployment, propagation, UEs, mobility) in which the model will later be used. The systems and methods herein can thus be used to train AI models and agents for many near-PHY functions, such as scheduling, MU-MIMO, channel memory, and model-driven link adaptation. According to a second embodiment, there is a first node in a communications network for use in training a model using a machine learning process using Hybrid Automatic Repeat Request, HARQ, transmissions. The first node comprises a memory comprising instruction data representing a set of instructions, and a processor configured to communicate with the memory and to execute the set of instructions. The set of instructions, when executed by the processor, cause the processor to: reserve HARQ resources between a second node and a third node in the communications network for training of the model, and initiate a first test transmission from the second node to the third node using the reserved HARQ resources in order to obtain data with which to train the model.

According to a third aspect there is a computer program comprising instructions which, when executed on at least one processor, cause the at least one processor to carry out the method of the first aspect.

According to a fourth aspect there is a carrier containing a computer program according to the third aspect, wherein the carrier comprises one of an electronic signal, optical signal, radio signal or computer readable storage medium.

According to a fifth aspect there is a computer program product comprising non transitory computer readable media having stored thereon a computer program according to the third aspect.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a system according to some embodiments herein;

FIG. 2 illustrates a first node according to some embodiments herein;

FIG. 3 illustrates a method according to some embodiments herein; and

FIG. 4 is a signaling diagram according to some embodiments herein.

### DETAILED DESCRIPTION

The disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Generally, the communications network may comprise nodes. For example, network nodes and/or user devices (UEs). For example, a network node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Further examples of network nodes include but are not limited to core network functions such as, for example, core network functions in a Fifth Generation Core network (5GC).

A node may also comprise a user equipment (UE). A UE may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

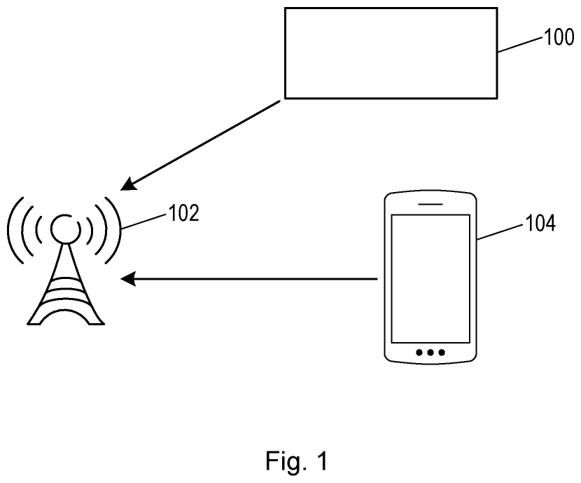

FIG. 1 illustrates a communications network (e.g. system) according to some embodiments herein. The communications network comprises a first node 100, a second node 102 and a third node 104. In this example, the first node 100 comprises an application or agent. The application 100 may coordinate training of a model using a machine learning process. The application 100 is in communication with the second node 102 which communicates with the third node 104. In this example, the second node 102 comprises a base station (e.g. eNodeB or gNodeB) and the third node 104 comprises a UE.

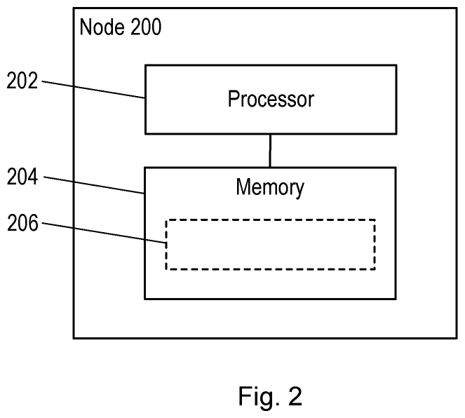

A first node (such as the node 100) is illustrated in more detail in FIG. 2 which shows a first node 200 in a communications network according to some embodiments herein. Generally, the first node 200 may comprise any component or network function (e.g. any hardware or software module) in the communications network suitable for performing the functions described herein. The first node 200 may, for example, be any of the types of nodes listed above.

In some embodiments, the first node may comprise an application. For example, an application can comprise software or processes that co-ordinate collection of the data with which to train the model. In one example, an application comprises software that communicates with base stations (via network interfaces, remote procedure calls or inter-process communication). Said base-stations provide (e.g. through an API or command line interface) the means for reserving HARQ processes.

In another example, an application comprises Software or a virtual network function (VNF) implementing a reinforcement learning agent. In another example, an application comprises Software/VNF implementing data collection for supervised training of machine learning models. More generally, an application may comprise any software or hardware component configured to obtain data with which to train a model in the manner described herein.

The first node 200 is configured (e.g. adapted, operative, or programmed) to perform any of the embodiments of the method 300 as described below. It will be appreciated that the first node 200 may comprise one or more virtual machines running different software and/or processes. The first node 200 may therefore comprise one or more servers, switches and/or storage devices and/or may comprise cloud computing infrastructure or infrastructure configured to perform in a distributed manner, that runs the software and/or processes.

The first node 200 may comprise a processor (e.g. processing circuitry or logic) 202. The processor 202 may control the operation of the first node 200 in the manner described herein. The processor 202 can comprise one or more processors, processing units, multi-core processors or modules that are configured or programmed to control the first node 200 in the manner described herein. In particular implementations, the processor 202 can comprise a plurality of software and/or hardware modules that are each configured to perform, or are for performing, individual or multiple steps of the functionality of the first node 200 as described herein.

The first node 200 may comprise a memory 204. In some embodiments, the memory 204 of the first node 200 can be configured to store program code or instructions 206 that can be executed by the processor 202 of the first node 200 to perform the functionality described herein. Alternatively or in addition, the memory 204 of the first node 200, can be configured to store any requests, resources, information, data, signals, or similar that are described herein. The processor 202 of the first node 200 may be configured to control the memory 204 of the first node 200 to store any requests, resources, information, data, signals, or similar that are described herein.

It will be appreciated that the first node 200 may comprise other components in addition or alternatively to those indicated in FIG. 2. For example, in some embodiments, the first node 200 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 202 of first node 200 may be configured to control such a communications interface to transmit to and/or receive from other nodes or network functions requests, resources, information, data, signals, or similar.

Briefly, in one embodiment, the first node 200 may be configured to reserve HARQ resources between a second node and a third node in the communications network for training of the model; and initiate a first test transmission from the second node to the third node using the reserved HARQ resources in order to obtain data with which to train the model.

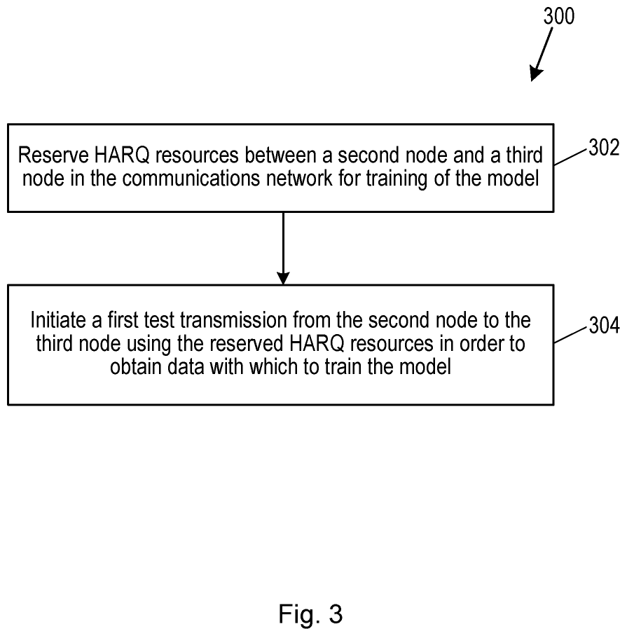

Turning to FIG. 3, there is a computer implemented method 300 according to some embodiments herein. The method 300 may be performed by a first node in a communications network for use in training a model using a machine learning process using Hybrid Automatic Repeat Request, HARQ, transmissions. The method 300 may be performed by the first node 200 as described above.

The method 300 comprises, in a first step 302, reserving HARQ resources between a second node and a third node in the communications network for training of the model. In a second step 304 the method then comprises initiating a first test transmission from the second node to the third node using the reserved HARQ resources in order to obtain data with which to train the model.

In this way dedicated resources may be reserved for performing test transmissions and gathering training data with which to train the model, thus allowing for data collection and experimentation in the physical layer of radio access technologies such as LTE and NR, allowing acquisition of such diverse datasets without affecting system performance. It may further enable data collection and experimentation in RAN in a programmable and transparent fashion. This is relevant, for example, to the collection of data and state-action-reward sets related to the physical-layer operation of said RAN.

The method 300 may be equivalent to creating a slice in the PHY for experimentation, e.g. that is completely independent of the legitimate uses of the network (user plane data transmissions). By using reserved HARQ resources, data collection and experimentation may be carried out at the most granular level, enabling the first node (AI model, data gathering) to experiment in the live conditions (deployment, propagation, UEs, mobility) in which the model will later be used. The method 300 can be used to train AI models and agents for many near-PHY functions, such as scheduling, MU-MIMO, channel memory, model-driven link adaptation. Another application of this disclosure is to tune/validate/model digital twins of the network.

In more detail, the model herein may comprise any type of model that is trained using a machine learning process. For example, in some embodiments, the machine learning model may comprise a supervised learning model that is trained using training data comprising example inputs and outputs (such as neural network models, Random Forrest models etc.) In some embodiments, the machine learning model may comprise an unsupervised learning model. In some embodiments the model may comprise a reinforcement learning agent, such as for example, a Q-learning agent, a SARSA (state-action-reward-state-action) agent. The skilled person will be familiar with machine learning processes and models that may be trained using a machine learning processes (otherwise known as machine-learning models).

A machine learning process (or algorithm) may be defined as a procedure that is run on data to create a machine learning model. The machine learning process comprises steps, processes and/or instructions through which data, generally referred to as training data, may be processed or used in a training process to generate a machine learning model. The process learns (e.g. updates or improves the model) from the training data. Machine learning processes can be described using math, such as linear algebra, and/or pseudocode, and the efficiency of a machine learning process can be analyzed and quantized. There are many machine learning processes, such as e.g. processes for classification, such as k-nearest neighbors, processes for regression, such as linear regression or logistic regression, and processes for clustering, such as k-means. Further examples of machine learning processes are Decision Tree algorithms and Artificial Neural Network algorithms. Machine learning algorithms can be implemented with any one of a range of programming languages.

The model, or machine learning model, may comprise both data and procedures for how to use new data to e.g. make a prediction, perform a specific task or for representing a real world process or system. The model represents what was learned by a machine learning process when trained by using training data, and is what is generated when running a machine learning process. The model represents e.g. rules, numbers, and any other algorithm-specific data structures or architecture required to e.g. make predictions. The model may e.g. comprise a vector of coefficients (data) with specific values (output from linear regression), a tree of if/then statements (rules) with specific values (output of a decision tree) or a graph structure with vectors or matrices of weights with specific values (output of an artificial neural network algorithm applying backpropagation and gradient descent). This disclosure centres around obtaining data with which to train a machine learning model in a communications network.

It will be understood that the disclosure herein may be used to obtain data with which to train any type of model, to perform a wide range of tasks in the communications network. However, non-limiting examples include for example, a model for selecting transmission parameters in the communications network; and a model for selecting appropriate pairings for Multi-user Multiple Input, Multiple Output, MU-MIMO, transmissions.

In some embodiments, the method 300 may be used to collect data to train a model to predict (improved) link adaptation procedures. Link adaptation refers to the problem of selecting appropriate transmission parameters (e.g. Modulation and Coding Scheme, MCS) based on some channel quality metric reported by the receiver (e.g. a Channel Quality Indicator, CQI). If the choice of parameters is too aggressive the error rate increases while if too conservative, decoding errors are avoided but spectrum efficiency falls. The method 300 could be used to reserve HARQ resources with which to experiment without impacting the legitimate transmissions. Based on both channel reports and decoding output from a reserved HARQ process from a selected UE, the first node could try out different MCS choices online, adapting the link adaptation curve on the fly. Reinforcement learning techniques could try to optimize spectral efficiency by deriving a reward signal from the outcome of the decoding. Furthermore, the first node could train multiple link adaptation agents, specializing them to different classes of UEs (e.g. based on UE capability). In another example, an unsupervised learning model could be used, and based on CQI, MCS and decoding, group UEs into different classes (e.g. clusters).

With respect to MU-MIMO scheduling, in MU-MIMO a set of UEs is scheduled on resource elements that overlap in time and frequency, benefiting from spatial separation. A good choice of UEs will ensure that all overlapping transmissions are correctly decoded, while a bad choice will have worse outcomes due to interference. In the context of this disclosure, the first node may collect data for training a model to learn to predict (good/appropriate) pairings (or more broadly, groupings) for MU-MIMO scheduling. The first node could try different UE groupings by making experimental MU-MIMO transmissions on sets of reserved HARQ resources and observing the outcomes. As data is collected, sets of UEs that are advantageous for joint scheduling can be learned.

Turning back to the method 300, as noted above, the first step 302 of the method 300 comprises reserving HARQ resources between a second node and a third node in the communications network for training of the model.

In some embodiments, the second node and/or the third node may comprise a network node such as a base station, eNodeB or gNodeB. In some embodiments the second node and/or third node may comprise a user equipment (UE). In some embodiments the second node may comprise a base station (e.g. gNodeB, or eNodeB) and the third node may comprise a user equipment (UE). In some embodiments, the first node may form part of (e.g. be comprised in) the second node. For example, the first node (e.g. base station) may reserve its own HARQ resources for use in training the model. Thus in some embodiments, a first node or “application” (or parts of the application) may be embedded in a base station (e.g. a second node).

In other embodiments, the first node and the second node may comprise different nodes in the communications network. In other words, the first node may reserve HARQ resources between two other nodes in the communications network.

In some embodiments the step 302 may comprise the first node selecting the second and third nodes (e.g. from a plurality of available nodes), for example, based on capability, or location of the second or third node(s).

For example, in an example where the second node comprises a base station and the third node comprises a UE, at initialization the first node may send a signal to one or more base stations, (or alternatively, send a signal directly to the core network, e.g. AMF, MME) to obtain parameters such as:
A list of UEs (e.g. UE identifiers) that are associated (connected) with each serving cell of interest.
Capabilities supported by the UEs in the list obtained above.

The set of UEs in a base station's cell may change for various reasons, including mobility, power management and inactivity. Changes in this set of available UEs may be communicated to the first node by the network nodes (e.g. base stations core network, or other relevant nodes). The first node may then update its pool of available (base station, serving cell, UE) sets to reflect current availability.

The first node may then select the second and third nodes from the one or more base stations and their associated UEs as obtained above. In other words, step 302 may comprise selecting the second node and the third node from a plurality of available nodes. The first node may use a selection policy to select (base station, serving cell, UE) sets on which to reserve the HARQ resources.

For example, the first node may select the second and third nodes based on, for example, the requirements of the model. For example, so as to obtain appropriate data with which to train the model (e.g. data that is varied and representative of a wide range of network conditions.)

In some embodiments where the second node and/or the third node comprises a user equipment, UE, step 302 may comprise selecting the UE based on motion associated with the UE. For example, the selection may comprise selecting (or prioritising) UEs that are stationary (e.g. fixed wireless access, FWA). The reservation of HARQ resources will generally have negligible impact on performance, however some delay may be observed in UEs that are moving at high speeds, thus selecting stationary UEs may avoid this.

In some embodiments, step 302 may comprise selecting a UE (as the second or third node) based on power available to the UE. For example, the selection criteria may avoid selecting UEs that are power limited. Of particular interest may be UEs that are non-battery powered. In this way experimental data may be collected in a manner that does not impact on the energy resources of the UEs involved.

In some embodiments, step 302 may comprise selecting a UE (as the second or third node) based on a channel quality report on a channel between the UE and the second node, or other configurable measurement outcome.

In some embodiments step 302 may comprise selecting a UE (as the second or third node) based on a capability of the UE. For example, the selection may be based on a class of UEs (derived from the capabilities obtained when determining a list of available UEs, as described above).

In some embodiments step 302 may comprise selecting a UE (as the second or third node) based on a load associated with the UE. For example, the selection may perform load balancing, this way the cost (in battery life) of performing experiments may be shared amongst UEs, minimizing end-user impact.

Once the second and third node are selected, the HARQ resources may then be reserved. In some embodiments step 302 may comprise sending a first message to the second node instructing the second node to reserve the HARQ resources between the second node and the third node. In some embodiments the first node may communicate with the second node, for example, over an Operations, Administration and Maintenance (OAM) interface.

Some example first messages for use in reserving HARQ resources between a base station and UE are as follows:
Reserve a specific HARQ process
   In this example, the first message indicates which HARQ process the first node wants to reserve for a set of base station, UE, serving cell and direction (UL, DL). E.g. the first message may comprise a process number (e.g. 7) to reserve.
Reserve a given set of HARQ processes
   In this example, the first message indicates which HARQ processes (>1) it wants to reserve for a set of base stations, UEs, serving cells and direction (UL, DL). E.g. the first message may comprise a set of process numbers e.g. 1, 3, 12 to reserve.
Reserve a HARQ process
   In this example, the first message requests a free HARQ process for a set of base station, UE, serving cell and direction (UL, DL). For example, a process that is not being currently used for that set of base station, UE, serving cell and direction (UL, DL) to deliver a transport block.
Reserve n HARQ processes
   In this example, the first message requests n (n>1) free HARQ processes for a set of base station, UE, serving cell and direction (UL, DL). For example, a set of processes that are not being currently used.

Note that there is no distinction between processes (they are only “identifiers” for a series of transmissions that have the same context).

Regarding implementation, in an example embodiment where the first node comprises an application and the second node comprises a base station, the HARQ reservation is performed by one or more base stations under a request from the application. For example, the base station software/firmware can provide some form of API to the application. Examples include:
remote procedure calls (the application calls the execution of a remote procedure on the base station)
inter process communication (the application process communicates with a base-station process running the PHY operations—this is useful for when the application runs in the base station)
function calls (application and baseband software/firmware are compiled and executed together)
The application could send interrupts to baseband hardware and read/write from shared memory regions (both run in the same hardware).

For the base station implementation in such an example, a reserved HARQ process is taken out of the pool of usable processes. This can be implemented in a myriad of ways such as flags, semaphores, separate lists (collections) for free or reserved processes. It could be that a state machine for the hardware implementing the base station PHY procedures is modified.

The skilled person will appreciate that these are examples only and that other messages and processes may also be used in order to achieve the functionality described herein.

The reserved HARQ resource(s) may thereafter be used exclusively for experimentation/data collection purposes, becoming unavailable for traditional user plane data transmission procedures (e.g. until explicit release by the first node).

As noted above, in step 304 the method then comprises initiating a first test transmission from the second node to the third node using the reserved HARQ resources in order to obtain data with which to train the model.

Generally the reserved HARQ resources may be used to obtain any data in the real (live) communications network that may be used to train a model. For example, the reserved resources may be used to obtain data such as state-action-reward sets for a reinforcement learning agent, labelled data for supervised learning models, and/or data to be analysed by unsupervised learning techniques or form part of a knowledge-base for a machine reasoning system.

In some embodiments, as noted above, the model may comprise a supervised learning model in which case the reserved HARQ resources may be used to obtain training data with which to train the supervised learning model.

In some embodiments, the model may comprise an unsupervised learning model and the data may be for use by the unsupervised learning model. As an example, where the model is for use in link adaptation (as described above), there may be unsupervised agents that are specialized for particular classes of UEs. In such an example, a data collection task for unsupervised learning might be to collect decoding information for the maximum number of CQI and MCS pairs. Based on this information, the UEs may be clustered using unsupervised learning, and for each cluster a Reinforcement Learning agent may then be assigned to perform the link adaptation.

In other embodiments, the model may comprise a reinforcement learning agent. The agent may be comprised in the first node. The agent may perform exploratory actions using the reserved HARQ resources. In other words, the model may comprise a reinforcement learning agent and the first test transmission may comprise an exploratory action of the reinforcement learning agent in order to train the reinforcement learning agent, for example, an experimental “action” performed by a reinforcement learning agent. Thus the reserved resources may be used by a reinforcement learning agent for exploratory actions (e.g. as though the reinforcement learning agent were operating in the live communications network). Generally, the first test transmission may thus comprise an experimental transmission.

As an example of an exploratory action, in the context of the example described above where the model is used for link adaptation, a reinforcement learning agent may have learned from past data that for a certain state, e.g. CQI value, a conservative MCS is expected to give the best reward. However, the agent might decide to use an aggressive MCS instead, in order to explore. Such exploration may allow for improved actions to be discovered, in circumstances, for example, where the data that the agent has learned on does not represent the particular action-state pair. The environment might have changed and the exploratory action may be better now (or continue to be an inappropriate action).

In some embodiments step 304 may comprise sending a second message to the second node, comprising information enabling the second node to send the first test transmission. In some embodiments, step 304 may comprise the first node instructing the second node to configure and/or trigger measurements. For example, the first test transmission may comprise a reference signal (e.g. CSI-RS, SRS) and the first node may send a message to the second node to trigger the second node to send the reference signal.

In terms of scheduling, in some embodiments, step 304 may comprise sending the first test transmission to the second node and allowing a scheduler in the second node to schedule transmission of the first test transmission. For example the second message (above) may allow a scheduler in the second node to schedule transmission of the first test transmission.

This enables the first node to initiate (or trigger) the first test transmission (and/or any other test transmissions described herein) using the reserved HARQ processes in a “batch mode” whereby one or more HARQ transmissions are designed by the first node for one or more UEs. Thus the first test transmission may be one of a batch of transmissions. The test transmissions in such a batch may be sent to the relevant second nodes (e.g. serving base stations). Schedulers in the second nodes may then schedule and execute the test transmissions in the order specified by the first node, and with the physical layer parameters selected by the first node. This mode may be advantageous for tasks that do not need to collect time-sensitive data and may therefore wait for the respective scheduler to execute the transmissions when it sees fit.

The first node may specify any available parameter for the first test transmission (non-limiting examples include transport block size, MCS, time and frequency resource elements, antenna mapping, number of spatial layers, number of codeword, precoding mode). The scheduler in the serving base station may then execute the first test transmission as specified (possibly scheduling other user plane transmissions in the same TTI), but without modifying it.

Optionally, if a few parameters are unspecified (i.e. not of interest to the first node), the scheduler in the serving base station may decide what to do, considering its user plane traffic and QoS demands (normal traffic operation). Examples of use for this mode include cases where the first node does not care about which specific time/frequency resources are used to execute the first test transmission.

In some embodiments, in addition to the first test transmission described above, the first node may craft and/or direct the second node to send out any control messages necessary to the implementation of said first test transmission. This may include for example, scheduling grants (in UL) and scheduling assignments (in DL), among other types of messages in their respective control channels (e.g. PDCCH, PUCCH).

In other embodiments, the first node may initiate (e.g. trigger) the first test transmission (and/or any other test transmissions described herein) using the reserved HARQ processes in an “interactive mode” whereby the first node designs the first test transmission (and associated control messages) with the same flexibility as described in the batch mode above, but instead of instructing the scheduler to execute the first test transmission when it sees fit, the first node can directly trigger transmissions from the second node at a particular TTI. In other words, step 304 may comprise initiating the first test transmission from the second node to the third node at a predefined transmission time interval, TTI. For example, the second message (described above) may indicate a predefined transmission time interval, TTI in which the second node is to make the first test transmission.

This is made possible because the first node is given exclusive access to time, frequency or spatial resources by the scheduler in the relevant second node (i.e. those resources are reserved to the first node, which in effect controls the scheduling of transmissions in them).

In embodiments where the first node comprises an application and the second node comprises a base station, to implement the interactive mode, the base station software/firmware can provide the following messages—procedures to the application.
Reserve specific Physical Resource Block (PRB)
   This message gives the application exclusive rights to design transmissions that will be executed using the resources (time, frequency, space) in the given PRB, on the given serving cell. Note that the application should also reserve at least one HARQ process to execute the transmissions using the messages above.
Reserve given set of PRBs
   This message gives the application exclusive rights to design transmissions that will be executed using the resources (time, frequency, space) in the given set of PRBs, on the given serving cell. Note that the application should also reserve at least one HARQ process to execute the transmissions using the messages above.

When resources are reserved by these messages, the base station or UEs will not execute any transmission on said resources unless instructed by the application. Interactive mode is more likely to be implemented if base station and application run in the same node and have some form of shared memory to cooperate. The skilled person will appreciate that these are examples only and that other messages may also be used in order to achieve the functionality described herein.

When designing a transmission for a reserved HARQ process, the first node may provide data (e.g. the content of the transmission itself) to the relevant second node. It is desirable that the experimentation transmissions do not interfere with the reception of legitimate transmissions to the same third node. This can be achieved in various ways, some examples of which are described as follows.

In some embodiments, the first test transmission may be designed to be invalid so that the third node will ignore the first test transmission. For example, the first test transmission may comprise at least one duplicated protocol data unit, PDU. For example, comprising duplicated contents, or a duplicated/reused sequence number. At reception the duplicated PDU will then be discarded by the RLC (or upper layers).

As another example, the first test transmission may comprise an invalid cyclic redundancy check, CRC value (e.g. in the transport block to be transmitted). In such a scenario, the third node may report in the HARQ process that the message had an error (essentially requesting a retransmission), but as the second node knows this is expected, it may break the loop and discard the request.

In some embodiments, the first test transmission is designed to request the third node to re-send a first previous transmission using different transmission parameters.

In some embodiments, the first test transmission may be sent in response to the second node receiving positive feedback, e.g. such as a HARQ acknowledgement ACK, from the third node in response to a second previous transmission from the second node to the third node. In such an example, the third node (having previously received the second previous transmission) will subsequently ignore the first test transmission (e.g. assuming that it is a duplicate of the previous second transmission). Put another way, the second node may ignore the positive feedback (HARQ ACK) from a previous transmission in the reserved resource.

In uplink (UL) the second node may avoid indicating to the third node that it should send new (e.g. previously unsent) data using the reserved HARQ process. Thus, genuine transmissions may be prevented from being sent in the reserved HARQ resources, ensuring that genuine non-test transmissions are not mixed in with test transmissions. As an example, in new radio (NR) the Downlink Control Information (DCI) would not carry the New-data Indicator (NDI) flag in a grant for the reserved HARQ process. This way the UE will retransmit the same (e.g. old) transport block as instructed. Put another way, the first test transmission may be initiated using transmission parameters that prevent new data (e.g. previously unsent) data from being sent using the reserved HARQ resources, from the third node to the second node.

Generally, once a transmission in a reserved HARQ process is concluded (i.e. HARQ feedback associated with the transmission is received) or the decoding of such transmission is finished (in UL), the second node may notify the first node. Conversely, if reports are configured by the first node, the completion of a report should be notified by the second node.

Thus, once the first test transmission is initiated, step 304 may comprise obtaining the data with which to train the model, from the second or third nodes. In some embodiments the data with which the model may be trained may be obtained through configured reports. For example, step 304 may further comprise obtaining or receiving a message comprising information such as a Channel-Quality Indicator (CQI), Rank Indicator (RI), Precoding-Matrix Indicator (PMI), Reference Signal Received Power (RSRP), Layer 1 RSRP (L1-RSRP) associated with the first test transmission (e.g. from the second node).

The outcome of the transmission(s) or report(s) above may be sent from the second node to the first node (e.g. from a base station to an application). The periodicity or delay associated with such reports may depend on whether batch mode or interactive mode, as described above, is being used. The information communicated (e.g. the obtained data) may include, but is not limited to:
i. The output of the decoding of a transmission (e.g. ACK, NACK)
ii. CQI
iii. PMI
iv. RSRP
v. L1-RSRP
vi. SINR
vii. Beam related information, such as best beam index, or RSRP per beam

Other examples include but are not limited to the key performance indicators (KPIs) found in the Third Generation Partnership Project Technical Specification: 3GPP TS 28.554.

In some embodiments, the sets (base station, serving cell, UE) where HARQ processes are reserved may differ from the sets where measurements and reporting is being performed. For example, the effect of a crafted transmission may be measured at other nodes (i.e. that are not the recipient for said message). Thus in some embodiments, the method 300 may further comprise initiating measurements (e.g. such as channel measurements or interference measurements) at a fourth node during the first test transmission. For example, the method 300 may further comprise sending a message to the fourth node to instruct the fourth node to make the channel measurements.

For example, in some embodiments, a transmission to/from one reserved HARQ process in UE A can overlap (e.g. in time, frequency, space) with a transmission to/from one reserved HARQ process in UE B. In another example, a transmission to/from one reserved HARQ process in UE A can overlap (e.g. in time, frequency, space) with resources where UE B is configured to perform measurements.

Put another way, the method 300 may comprise initiating a second test transmission from a fifth node to a sixth node that overlaps (e.g. in frequency, time, and/or space) with the first test transmission, and initiating channel measurements based on the first or second test transmissions. Thus reserved HARQ resources between different pairs of nodes can be used in a coordinated manner to obtain data.

There are various applications for which overlapping test-transmissions and/or measurements may be utilised. For example, if the overlapping transmissions come from the same network node to different UEs, this may be useful for the MU-MIMO pairing example, e.g. for obtaining data with which to train a machine learning model to predict (appropriate) MU-MIMO pairs. As another example, if two (or more) base-stations transmit to the same UE data can be obtained about multi-TRP (transmit-receive point) pairings (e.g. so that a model may be trained to select an optimal base station combination to reach a certain UE and to select multi-transmit-receive-point pairings). In another example, if the overlap occurs in resources where a group of UEs are configured to make channel measurements at the same time as the first transmission is sent, data may be obtained to learn about coverage and interference patterns (which may be used for example, to train a model to determine coverage areas and interference maps).

In some embodiments, the first node may further interact with another node or network function (e.g. SMLC, E-SMLC) to obtain positioning information for any UEs being used for experimental transmissions (or the set of UEs performing measurements). This may allow for the generation of datasets that provide a link between position in the coverage area and PHY properties.

In some embodiments the method (300) may further comprise training the model using the obtained data. For example, using the obtained data as training data with which to train the model. In some embodiments where the model comprises a reinforcement learning agent and the first test transmission comprises an action determined by the reinforcement learning agent, the method may comprise providing a reward (or feedback) to the reinforcement learning agent based on the obtained data.

Generally, the method 300 may be repeated (e.g. for subsequent test transmissions) until the first node has executed all its intended transmissions (data collection has been completed). Alternatively, the method may repeat at regular intervals (or continuously) in order to continuously train the model and ensure its validity.

The method 300 may further comprise releasing the reserved HARQ resources (e.g. when training on the particular resources has been completed).

The HARQ resources may be released, for example, by the first node sending a third message.

The third message may comprise a command to:
Release a specific HARQ process; or
Release a given set of HARQ processes
   Note that here, the first node could explicitly indicate which HARQ process number(s) it is releasing for a set of base station, UE, serving cell and direction (UL, DL) to deliver a transport block.

The release messages are relevant for uplink, for example, for second node (e.g. a base station) to indicate to a third node (e.g. a UE) that it has successfully decoded a transport block.

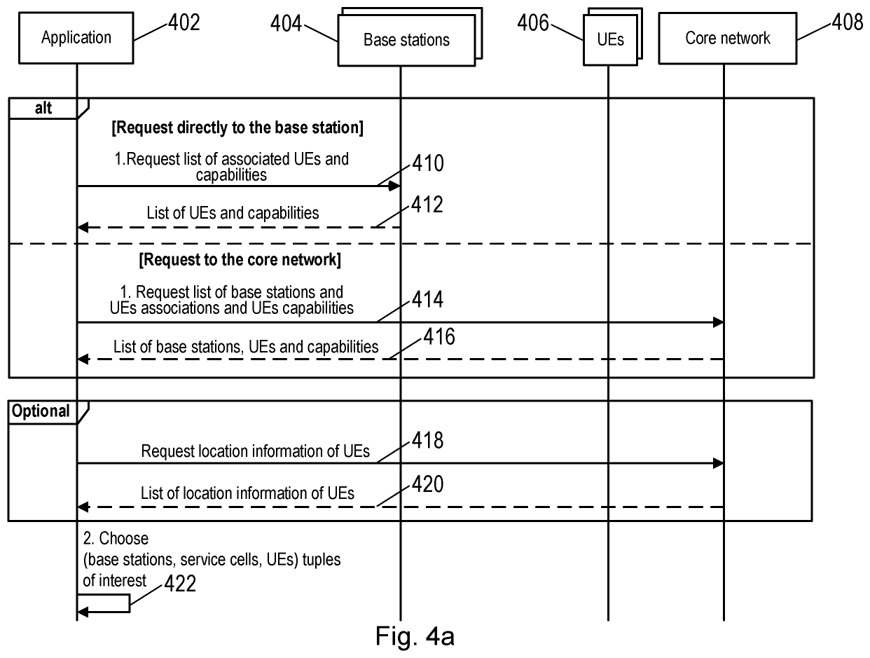

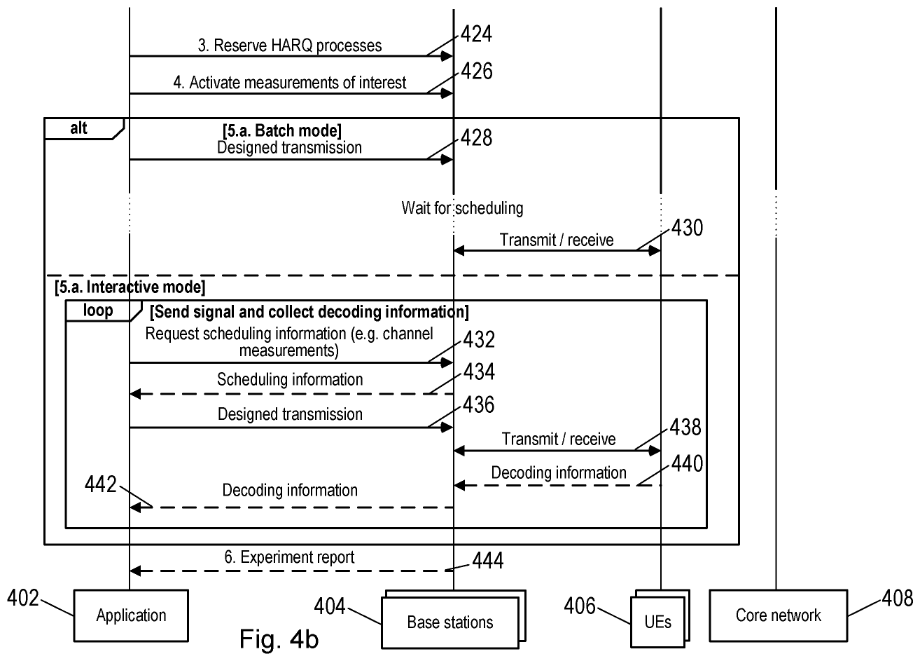

Turning now to FIGS. 4a and 4b which show an example signaling diagram according to an embodiment herein. In this embodiment, the first node comprises an application 402, the second node comprises a base station 404 and the third node comprises a UE 406. The first node 402 may further interact with a core network node 408. The embodiment is described with respect to one base station and one UE, however it will be appreciated that the embodiment can be generalized to a plurality of test transmissions (initiated by the application 402) between a plurality of base stations and a plurality of respective UEs.

In this embodiment, the application 402 performs the method 300. In detail, the following steps are performed.
410: The application 402 sends a message to the base station 404 requesting a list of UEs associated with the serving cell(s) of the base station 404 and the capabilities of the UEs in the list of UEs.
412: Base station 404 sends the requested list to the application 402.
414: Alternatively to steps 410 and 412, the application 402 sends a message to the core network 408 requesting a list of base stations, UEs associated with the base stations 404 and capabilities of the associated UEs.
416: Core network 408 sends the requested list to the application 402.
418: The application may also send a message to the core network 408 to obtain location information related to the UEs.
420: The Core network may send a message back to the application containing the location information of the UEs.
422: The application selects (base station, service cell, UE) tuples, This may be based on factors such as the capability of the UEs, data requirements of the model being trained, availability of HARQ resources etc, as described in detail above with respect to step 302 of the method 300 above.
424: The application 402 reserves 302 HARQ resources between the UE 406 and the base station 404 for training of the model.
426: Optionally, the application 402 configures measurements of interest that are to take place during the first test transmission. This step may be used in examples where a test transmission is sent and measurements are performed (but where the first node is not interested in the decoding outcome). This step may also be used in cases where the second node makes a transmission to the third node and where measurements are made at another node (e.g. interference mapping).
428: The application 402 initiates 304 a first test transmission from the base station to the UE using the reserved HARQ resources in order to obtain data with which to train the model. The first test transmission is initiated in a batch mode. And thus the application initiates the transmission such that it is scheduled by a scheduler on the base station 404.
430: The base station 404 makes the first test transmission, which is received by the UE 406. The UE may acknowledge the first test transmission and/or send another transmission in reply.
432: As an alternative to steps 428 and 430, the application 402 may control when the test first test transmission is performed. The application 402 may thus send a message to the base station to request scheduling information (e.g. channel measurements).
434: The base station 404 may then send a message in reply to the application, comprising the scheduling information.
436: The application may then send a message to the base station indicating when the first test transmission should be scheduled and/or indicating transmission parameters associated with the first test transmission.
438: Based on this, the base station may schedule the first test transmission to the UE.
440: The UE may then send decoding information to the base station.
442: The decoding information may then be sent to the application. Based on this information, the application 402 may repeat steps 432, 434, 436, 438, 440 and 442 again to acquire the intended data.
444: An experiment report may then be sent to the application, e.g. comprising data which may be used to train the model.

Turning now to another embodiment, there is a computer program comprising instructions which, when executed on at least one processor, cause the at least one processor to carry out any of the embodiments of the method described herein, such as the method 300. According to another embodiment, there is a carrier containing a computer program as above. The carrier may comprise one of an electronic signal, optical signal, radio signal or computer readable storage medium. According to another embodiment, there is a computer program product comprising non transitory computer readable media having stored thereon a computer program as above.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer implemented method performed by a first node in a communications network for use in training a model using a machine learning process using Hybrid Automatic Repeat Request, HARQ, transmissions, the method comprising:
reserving HARQ resources between a second node and a third node in the communications network for training of the model; and
initiating a first test transmission from the second node to the third node using the reserved HARQ resources in order to obtain data with which to train the model.

2. A method as in claim 1, wherein the model comprises:
a reinforcement learning agent and wherein the first test transmission comprises an exploratory action of the reinforcement learning agent in order to train the reinforcement learning agent, or a supervised learning model or an unsupervised learning model and wherein the data comprises training data with which to train the respective model.

3. (canceled)

4. A method as in claim 1, wherein the first test transmission comprises an experimental transmission.

5. A method as in claim 1, wherein the first test transmission is designed to be invalid so that the third node will ignore the first test transmission.

6. A method as in claim 5, wherein the first test transmission comprises:
at least one duplicated protocol data unit, PDU, or
an invalid cyclic redundancy check, CRC value.

7. (canceled)

8. A method as in claim 1, wherein the first test transmission is designed to request the third node to re-send a first previous transmission using different transmission parameters.

9. A method as in claim 8 wherein the step of initiating a first test transmission from the second node to the third node using the reserved HARQ resources is performed in response to the second node receiving a HARQ acknowledgement, HARQ ACK, from the third node in response to a second previous transmission from the second node to the third node.

10. A method as in claim 1, wherein the first test transmission is initiated using transmission parameters that prevent new, previously unsent, data from being sent from the third node to the second node, using the reserved HARQ resources.

11. A method as in claim 1, further comprising:
selecting the second node and the third node from a plurality of available nodes, and
wherein the second node and/or the third node comprises a user equipment, UE, and wherein the UE is selected based on:
motion associated with the UE;
power available to the UE;
a channel quality report on a channel between the UE and the second node;
a capability of the UE; and/or
a load associated with the UE.

12. (canceled)

13. A method as in claim 1, further comprising:
initiating measurements at a fourth node during the first test transmission.

14. A method as in claim 1, further comprising:
initiating a second test transmission from a fifth node to a sixth node that overlaps with the first test transmission; and
initiating channel measurements based on the first or second test transmissions.

15. A method as in claim 1, wherein the model is for selecting transmission parameters in the communications network.

16. A method as in claim 1, wherein the model is for selecting pairings for Multi-user Multiple Input, Multiple Output, MU-MIMO, transmissions, or multi-transmit-receive-point pairings.

17. A method as in claim 1, wherein the step of reserving HARQ resources between a second node and a third node in the communications network for training of the model comprises sending a first message to the second node instructing the second node to reserve the HARQ resources.

18. A method as in claim 1, wherein the step of initiating a first test transmission from the second node to the third node using the reserved HARQ resources in order to obtain data with which to train the model comprises:
sending a second message to the second node, comprising information enabling the second node to send the first test transmission.

19. A method as in claim 18 wherein the second message:
indicates a predefined transmission time interval, TTI in which the second node is to make the first test transmission, or
allows a scheduler in the second node to schedule transmission of the first test transmission.

20-22. (canceled)

23. A first node in a communications network for use in training a model using a machine learning process using Hybrid Automatic Repeat Request, HARQ, transmissions, the first node comprising:
a memory comprising instruction data representing a set of instructions; and
a processor configured to communicate with the memory and to execute the set of instructions, wherein the set of instructions, when executed by the processor, cause the processor to:
reserve HARQ resources between a second node and a third node in the communications network for training of the model; and
initiate a first test transmission from the second node to the third node using the reserved HARQ resources in order to obtain data with which to train the model.

24. A first node as in claim 23 further configured to perform a computer implemented method performed by a first node in a communications network for use in training a model using a machine learning process using Hybrid Automatic Repeat Request, HARQ, transmissions, the method comprising:
reserving HARQ resources between a second node and a third node in the communications network for training of the model; and
initiating a first test transmission from the second node to the third node using the reserved HARQ resources in order to obtain data with which to train the model, wherein the model comprises:
a reinforcement learning agent and wherein the first test transmission comprises an exploratory action of the reinforcement learning agent in order to train the reinforcement learning agent, or a supervised learning model or an unsupervised learning model and wherein the data comprises training data with which to train the respective model.

25. A computer program comprising instructions which, when executed on at least one processor, cause the at least one processor to carry out a method according to claim 1.

26. (canceled)

27. A computer program product comprising non transitory computer readable media having stored thereon a computer program according to claim 25.
